(19) United States
(12) Patent Application Publication
(10) Pub. No.: US 2004/0084307 A1
(43) Pub. Date: May 6, 2004

(54) Biosensor, biosensor array, and method for manufacturing a plurality of biosensors

(76) Inventors: Hyo-kyum Kim, Daejeon-city (KR); Suk-kil Kang, Kyungki-do (KR); Dong-ho Shin, Daejeon-city (KR); Youn-tae Kim, Daejeon-city (KR); Hae-sik Yang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/349,233

(22) Filed: Jan. 22, 2003

(30) Foreign Application Priority Data
Oct. 31, 2002 (KR) 2002-67052

(51) Int. Cl. G01N 27/26

(52) U.S. Cl. 204/403.01; 427/123

(57) ABSTRACT

A biosensor, a biosensor array, and an efficient method for simultaneously manufacturing a plurality of biosensors with improved reproducibility are provided. The method involves forming a sacrificial layer on a substrate. Next, a lower insulating layer is formed on the sacrificial layer, and a plurality of electrodes and electrode pads are formed on the lower insulating layer. An upper insulating layer is formed on the lower insulating layer with the plurality of electrodes and electrode pads, and a hard mask layer is formed on the upper insulating layer. After a portion of the hard mask layer and the upper insulating layer is etched to expose the plurality of electrodes and electrode pads, the remaining portion of the hard mark layer and the sacrificial layer is removed, so that the substrate is separated from the insulating layer. After an enzyme layer or a composite layer of enzyme and polymer layers, or a plated layer is formed selectively on the exposed electrodes, the top of the resultant structure is coated with an external layer. Finally, the resultant structure is divided into individual biosensors.

### BACKGROUND OF THE INVENTION

This application claims priority from Korean Patent Application No. 2002-67052, filed on Oct. 31, 2002, in the Korean Intellectual Property Office, the disclosure of which is incorporated herein in its entirety by reference.

1. Field of the Invention

The present invention relates to a biosensor, and more particularly, to an electrochemical biosensor and biosensor array and an efficient method for manufacturing a plurality of electrochemical biosensors.

2. Description of the Related Art

Recently, the use of biosensors in analyzing biological samples is becoming common more and more in the medical field. Biosensors have the ability to accurately identify and quantize a target biochemical species of interest under the conditions where different kinds of biomolecules are mixed up, using a substance specifically responsive to the target biochemical species. Biosensors should comply with the following requirements. First, the biosensor should be able to react specifically with only a particular substance. Second, the biosensor should be able to accurately and easily detect a target analyte even if sample amounts are very small. Thirds, the biosensor should be able to readily and conveniently measure samples at an ambient temperature and pressure without a need for pre-separation of the target analyte.

Technical progress in bio-microelectro mechanical systems (MEMS) has promoted the development of biosensors. Bio-MEMS technology enables reproducible, economical, mass fabrication of micro-electrode structures to be used in biosensors, based on general semiconductor fabricating processes. Biosensors can be implemented from such electrode structures fabricated using the Bio-MEMS technology through appropriate processes.

Among different types of biosensors, an electrochemical biosensor using enzymes is most widely used in hospitals and clinical laboratories because it is convenient to apply and has a high sensitivity. The biosensor using enzyme reactions detects molecules either using spectroscopic colorimetry or using an electrochemical electrode. Spectroscopic colorimetry takes a longer time to make a measurement than a method using the electrochemical electrode and cannot accurately detect a target biological analyte due to an error originating from the turbid biological sample.

For these reasons, the method using an electrochemical electrode, which takes a shorter amount of time and leads to a smaller error in detection, has become popular in recent years. According to the method using an electrochemical electrode, an analytic reagent is immobilized on the electrode, a sample is applied to the electrode with the analytic reagent, and a predetermined potential is applied to the electrode, in order to quantize a particular analyte in the sample.

As an example of a biosensor using the electrode method, an enzyme-electrode biosensor is formed as a stack of an electrode/(internal layer/) enzyme layer/external layer. The electrode of the biosensor is formed through general semiconductor fabricating processes. The internal layer and the enzyme layer with an enzyme immobilized thereon are separately formed through electrochemical polymerization, deep coating, spin coating, casting, and/or dispensing. The external layer is formed only through casting or dispensing.

Although in the conventional biosensor multiple electrodes can be simultaneously formed using a semiconductor fabricating technique, the enzyme layer and the external layer (polymeric layer) are separately formed on each electrode. Therefore, efficiency and reproducibility in the manufacture of biosensors are low.

### SUMMARY OF THE INVENTION

The invention provides a biosensor with improved efficiency and reproducibility in production.

The invention also provides a biosensor array that can be manufactured efficiently by forming an enzyme layer and an external layer simultaneously on a plurality of electrodes on a substrate.

The invention also provides an efficient method for simultaneously manufacturing a plurality of biosensors.

According to an aspect of the present invention, there is provided a biosensor comprising: a detection unit including a working electrode, a reference electrode, and a auxiliary electrode arranged at constant intervals; a pad unit including electrode pads electrically connected to the respective working electrode, reference electrode, and auxiliary electrode of the detection unit; and a connection unit to connect the working electrode, reference electrode, and auxiliary electrode of the detection unit with the electrode pads of the pad unit, respectively, wherein the detection unit, the pad unit, and the connection unit are arranged in a line.

Alternatively, an additional layer may be plated on the reference electrode. In this case, the additional layer may be formed of a composite layer of silver and silver chloride layers or an iridium oxide layer. Alternatively, an enzyme layer or a composite layer of internal and enzyme layers may be formed on the working electrode.

According to another aspect of the present invention, there is provided a biosensor array in which a plurality of biosensors, each of which comprises a detection unit including a plurality of electrodes, a pad unit including a plurality of electrode pads to supply power to the detection unit and to receive the electrochemical signal from the detection unit, and a connection unit to connect the detection unit with the pad unit, the detection unit, the pad unit, and the connection unit being arranged in a line, are radially arranged at constant intervals on a substrate such that the detection unit is close to the center of the substrate, wherein the electrode pads of the plurality of biosensors are divided in groups and are connected to separate wires, so that the same level of voltage can be applied to each group of electrode pads.

According to another aspect of the present invention, there is provided a method for manufacturing a plurality of biosensors, the method comprising forming a sacrificial layer on a substrate. Next, a lower insulating layer is formed on the sacrificial layer, and a plurality of electrodes and electrode pads are formed on the lower insulating layer. An upper insulating layer is formed on the lower insulating layer with the plurality of electrodes and electrode pads, and a hard mask layer is formed on the upper insulating layer. After a portion of the hard mask layer and the upper insulating layer is etched to expose the plurality of electrodes and electrode pads, the remaining portion of the hard mark layer and the sacrificial layer is etched, so that the substrate is separated from the insulating layer, resulting in a biosensor array. After an enzyme layer or a composite layer of enzyme and polymer layers, or a plated layer is formed selectively on the exposed electrodes, the top of the resultant structure is coated with an external layer. Finally, the resultant structure is divided into individual biosensors.

In the method according to the present invention, the lower insulating layer may be formed of a polymer layer.

Each of the biosensors comprises a working electrode, a reference electrode, and an auxiliary electrode, the plated layer is formed selectively on the reference electrode, and the enzyme layer or the composite layer of enzyme and polymer layers is formed selectively on the working electrode.

In the method according to the present invention, forming the plated layer and the enzyme layer or the composite layer of enzyme and polymer layers on the electrodes is achieved using a fluidic multi-electrochemical system comprising a lower plate having a hole to fix the biosensor array therein and an upper plate having an opening through which fluid is supplied to the electrodes of the biosensor array and having wires to supply power to the electrode pads of the biosensor array.

In the method according to the present invention, the resultant structure is divided into the individual biosensors using laser ablation or common cutting or plasma etching.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of a biosensor according to an embodiment of the present invention;

FIG. 2 is an enlarged view of a detection unit of the biosensor shown in FIG. 1.

FIG. 3 is a sectional view taken along line A-A′ in FIG. 2;

FIG. 4 is a plan view showing a state where a plurality of biosensors is arranged in an array on a substrate;

FIGS. 5A through 5G are sectional views illustrating each step of a method for manufacturing a plurality of biosensors, according to the present invention; and

FIG. 6 is an exploded perspective view of a fluidic multi-electrochemical system, which can be used to simultaneously manufacture a plurality of biosensors according to the present invention.

### DETAILED DESCRIPTION OF THE INVENTION

Embodiments of the present invention will be described in detail with reference to the accompanying drawings. This invention may, however, be embodied in many different forms and should not be construed as being limited to the embodiments set fourth herein; rather, these embodiments are provided so that this disclosure will be thorough and complete, and will fully convey the concept of the invention to those skilled in the art. In the drawings, the sizes of elements are exaggerated for clarity, and like reference numerals are used to refer to like elements throughout. It will also be understood that when a layer is referred to as being “on” another layer or substrate, it can be directly on the other layer or substrate, or intervening layers may also be present.

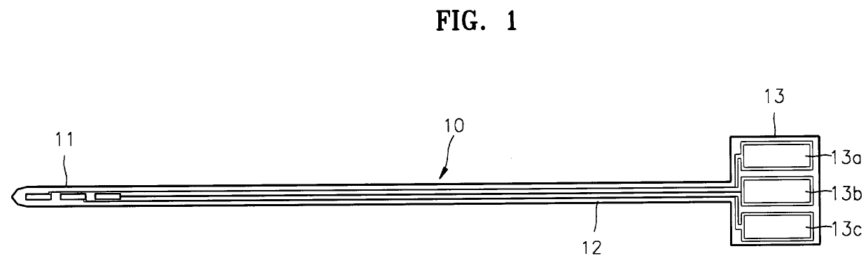

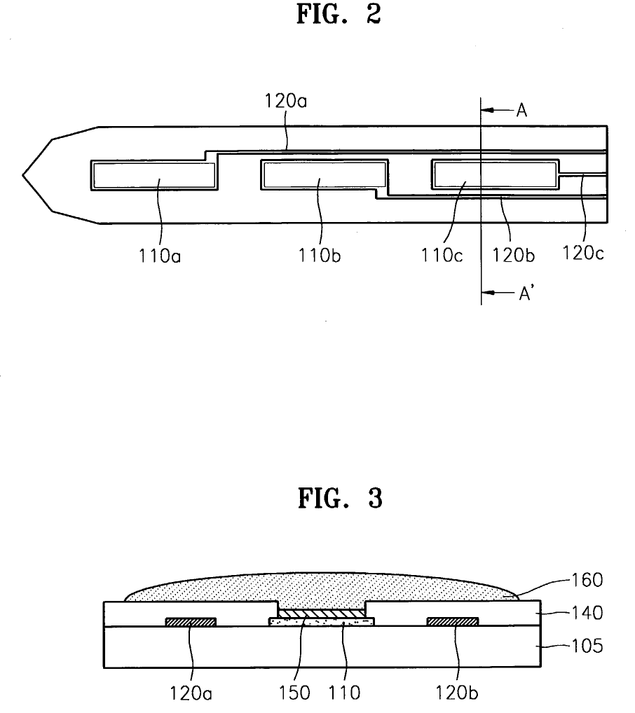

FIG. 1 is a plan view of a biosensor according to an embodiment of the present invention. FIG. 2 is an enlarged view of a detection unit of the biosensor shown in FIG. 1. Referring to FIGS. 1 and 2, a biosensor 10 includes a detection unit 11, a connection unit 12, and a pad unit 13. In particular, the detection unit 11 senses a biological analyte and generates a signal through a reaction with the biological analyte. The detection unit 11 includes a working electrode 110a, a reference electrode 110b, an auxiliary electrode 110c, and conductive wires 120, 120b, and 120c to connect the working electrode 110a, the reference electrode 110b, and the auxiliary electrode 110c with electrode pads 13a, 13b, and 13c, respectively. The arrangement and order of the working electrode 110a, the reference electrode 110b, and the auxiliary electrode 11Oc may be changed.

The connection unit 12 is formed of a group of conductive wires 120a, 120b, and 120c connected with the respective working electrode 110a, reference electrode 110b, and auxiliary electrode 110c.

The pad unit 13 includes a working electrode pad 13a connected with the working electrode 110a, a reference electrode pad 13b connected with the reference electrode 110b, and an auxiliary electrode pad 13c connected with the auxiliary electrode 110c. The arrangement of the working electrode pad 13a, the reference electrode pad 13b, and the auxiliary electrode pad 13c may also be changed according to the arrangement of the working electrode 110a, the reference electrode 110b, and the auxiliary electrode 110c. The working electrode 110a, the reference electrode 110b, and the auxiliary electrode 110c, and the working electrode pad 13a, the reference electrode pad 13b, and the auxiliary electrode pad 13c may be formed on the same plane.

FIG. 3 is a sectional view taken along line A-A′ in FIG. 2. The electrode 110 illustrated in FIG. 3 indicates, rather than be limited to a particular electrode, any of the working electrode 110a, the reference electrode 110b, and the auxiliary electrode 110c. Referring to FIG. 3, on a lower insulating layer 105 the electrode 110 and electrode pads (not shown in FIG. 3 but indicated by reference numerals 13a, 13b, and 13c in FIG. 1) are formed. An upper insulating layer 140 is formed on the lower insulating layer 105 to expose the electrode 110. The electrode 110 may be covered with a predetermined layer 150. In this case, if the electrode 110 is the working electrode 110a, the predetermined layer 150 may be, for example, an enzyme layer or a composite layer of internal and enzyme layers that is capable of electrochemical detection. If the electrode 110 is the reference electrode 110b, the predetermined layer 150 may be a plated layer of, for example, iridium oxide (IrOₓ). An external layer 160 is formed over the upper insulating layer 140. This sectional structure of the biosensor according to the present invention will be described in detail later in connection with the manufacture thereof.

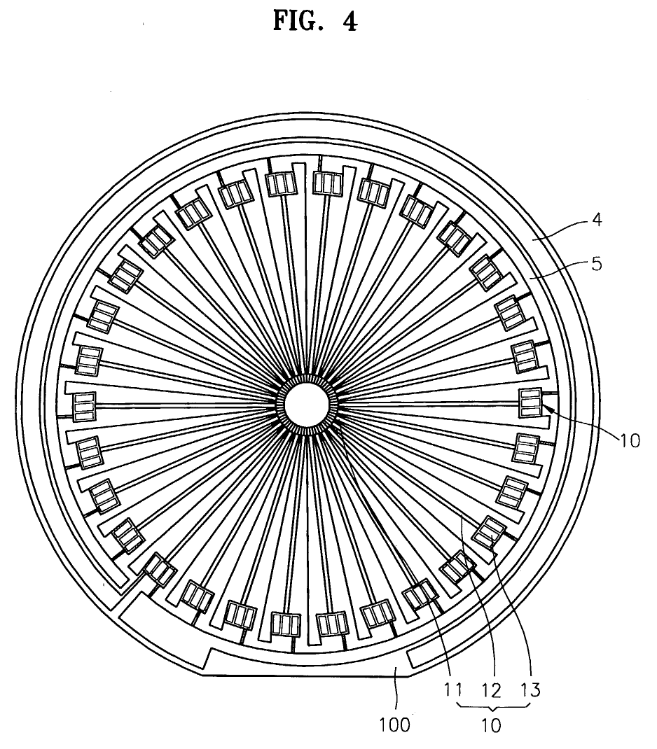

FIG. 4 is a plan view showing a state where a plurality of biosensors are arranged in an array on a substrate. Referring to FIG. 4, a plurality of biosensors 10, each of which has a bar shape, are radially positioned at constant intervals on a substrate, such that the detection unit 11 of each of the biosensors 10 having multiple reaction sites (electrodes) is close to the center of the substrate 100, and the pad unit 13 is close to and along the circumference of the substrate 100. The working electrode 110a, the reference electrode 110b, and the auxiliary electrode 110c of the detection unit 11 are electrically connected with the working electrode pad 13a, the reference electrode pad 13b, and the auxiliary electrode pad 13c, respectively. All the working electrode pads 13a, the reference electrode pads 13b, and the auxiliary electrode pads 13c radially arranged over the substrate 100 are divided into groups and are electrically connected together in each group by wire 4 or 5, so that the same level of voltage can be applied to each group of electrode pads. Via electrical connection of the working electrode pads 13a, the reference electrode pads 13b, and the auxiliary electrode pads 13c within groups, the surfaces of multiple biosensors can be processed simultaneously.

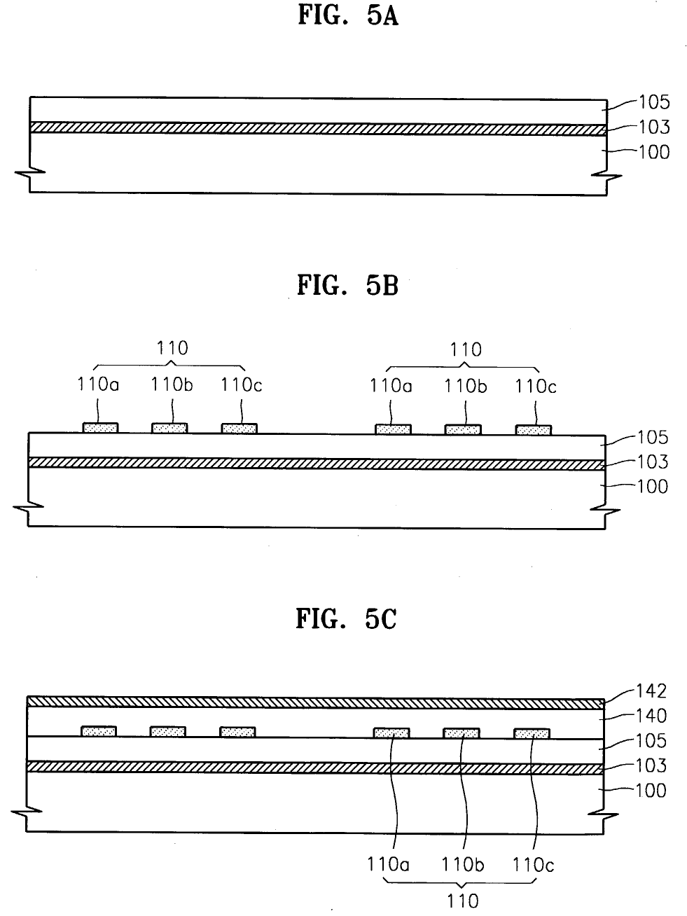

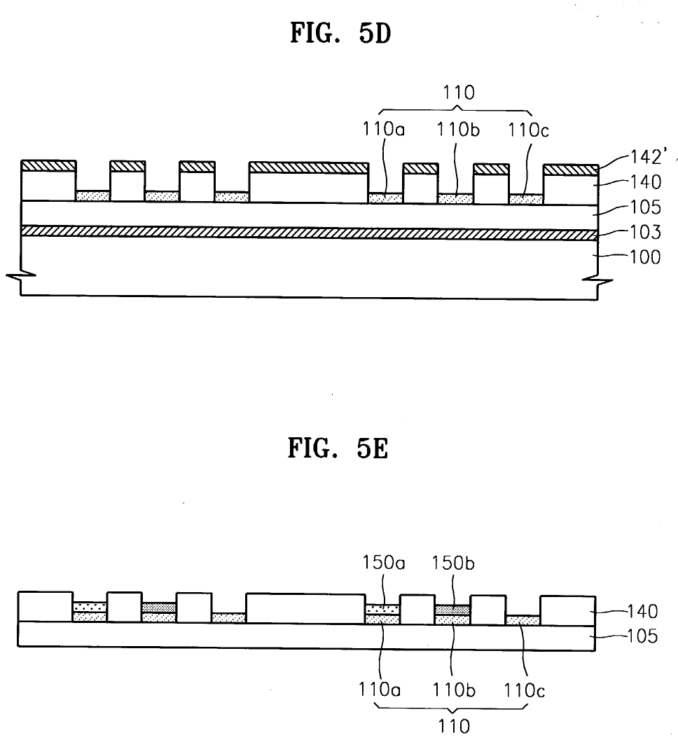

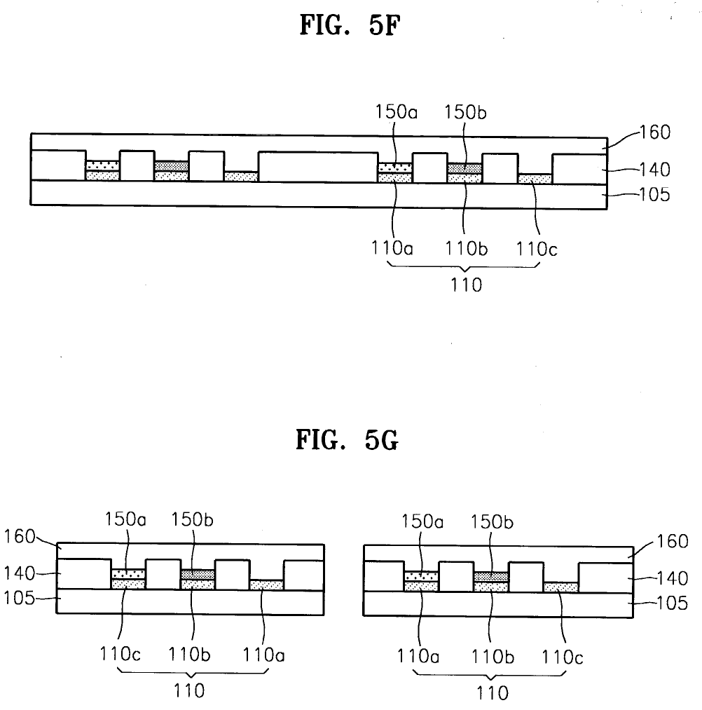

A method for manufacturing a plurality of biosensors as described above will be described with reference to FIGS. 5A through 5G.

Referring to FIG. 5A, a sacrificial layer 103 is initially formed on a cleaned substrate 100. A lower insulating layer 105 is formed on the sacrificial layer 103. The lower insulating layer 105 may be formed of a flexible, biocompatible material, for example, a polymeric material, such as polyimide or a liquid crystal polymer.

Next, referring to FIG. 5B, a conductive layer, for example, a platinum (Pt) layer or gold (Au) layer, is deposited on the lower insulating layer 105 and patterned into a plurality of electrodes 110 and electrode pads (not shown in FIG. 5B but indicated by reference numerals 13a, 13b, and 13c in FIG. 1). The plurality of electrodes 110 includes the working electrode 110a, the reference voltage 110b, and the auxiliary electrode 110c, but the arrangement of the electrodes 110 is not limited to this structure. In this step, the plurality of electrode 110 and the electrode pads 13a, 13b, and 13c are simultaneously formed in an array, as shown in FIG. 4. Alternatively, a plurality of working electrodes 110a may be formed for each biosensor according to the use of the biosensor.

Next, referring to FIG. 5C, an upper insulating layer 140 and a hard mask layer 142 are sequentially formed on the lower insulating layer 105 with the electrodes 110. The upper insulating layer 140 may be formed of the same material as the lower insulating layer 140. It is preferable that the hard mask layer 142 be formed of a material having a predetermined etch selectivity with respect to the upper insulating layer 140 and capable of being easily removed from the same. For example, if the upper insulating layer 140 is formed of a polymer, the hard mask layer 142 may be formed of a metal layer, such as a titanium (Ti) layer or chromium (Cr) layer.

Next, referring to FIG. 5D, the hard mask layer 142 is etched through a known photolithography process into a hard mask pattern 142′ covering a region below which no electrode 110 and electrode pad (not shown) is formed. Next, the upper insulating layer 140 is etched with the hard mask pattern 142 serving as a mask until the surfaces of the electrodes 110 and electrode pads are exposed.

Next, referring to FIG. 5E, the hard mask pattern 142′ is formed using a predetermined etchant. At this time, the sacrificial layer 103 that has the same etch selectivity as the hard mask layer 142 is also removed. As a result, a structure including the lower insulating layer 105, the electrodes 110, the electrode pads (not shown), and the upper insulating layer 140 is separated from the substrate 100. Next, an enzyme layer 150a is formed selectively only on the working electrode 110a, excluding the reference and auxiliary electrodes 110b and 110c, using a fluidic electrochemical system described later. Alternatively, a composite layer of internal and enzyme layers may be formed instead of the single enzyme layer 150a. In this case, the internal layer may be formed through photopolymerization, or pH-sensitive polymer precipitation. In addition, a plated layer 150b, for example, a composite layer of silver and silver chloride layers or an iridium oxide layer, is formed selectively on the reference electrode 110b.

After the surface of the resulting structure is coated with an external layer 160, as shown in FIG. 5F, the external layer 160, the upper insulating layer 140, and the lower insulating layer 105 are divided into individual biosensors, for example, using laser ablation or common cutting or plasma etching.

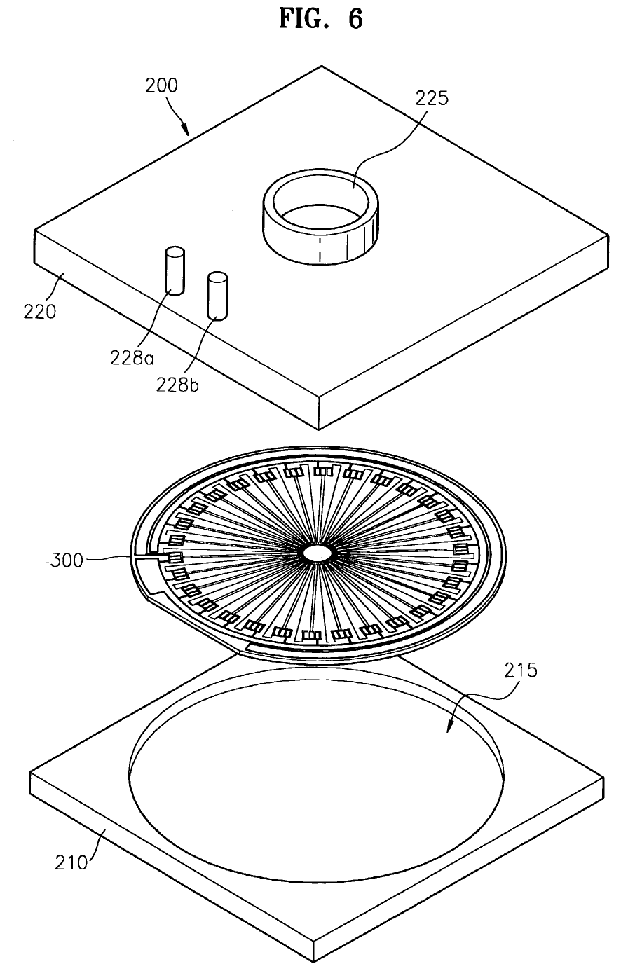

FIG. 6 shows a fluidic multi-electrochemical system 200, which can be used to manufacture biosensors according to the present invention. As in the step described with reference to FIG. 5E, the fluidic multi-electrochemical system 200 shown in FIG. 6 can be used to form the internal layer and/or the enzyme layer 150a, the plated layer 150b, the external layer 160, etc., on the electrodes 110.

The fluidic multi-electrochemical system 200 includes a lower plate 210 and an upper plate 220. The lower plate 210, to which the biosensor array 300 is fixed, has a hole 215 of an appropriate size to receive and tightly fix the biosensor array 300 therein. The biosensor array 300 refers to the structure as shown in FIG. 5E from which the substrate 100 has been removed. The upper plate 220 has an opening 225 through which the electrodes (not shown in FIG. 6) of the biosensor array 300 can be made into contact with fluid. Connection terminals 228a and 228b are formed in the upper plate 220 to appropriately supply an electrical signal to the pad units 13 (shown in FIG. 4).

The above-described fluidic multi-electrochemical system 200 can be used to form the enzyme layer 150a or the plated layer 150b simultaneously and selectively on particular electrodes constituting the detection units 11 (shown in FIG. 4).

As described above, according to the present invention, a plurality of biosensors with the electrodes are radially arranged, and the electrode pads of the biosensors are electrically connected together in separate groups to receive the same level of voltage in each group. Next, an internal layer, an enzyme layer, a plated layer, an external layer, etc., are formed simultaneously on multiple electrodes using the fluidic multi-electrochemical system. As a result, a number of biosensors can be simultaneously manufactured with improved reproducibility.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A biosensor comprising:
a detection unit including a working electrode, a reference electrode, and a auxiliary electrode arranged at constant intervals;
a pad unit including electrode pads electrically connected to the respective working electrode, reference electrode, and auxiliary electrode of the detection unit; and
a connection unit to connect the working electrode, reference electrode, and auxiliary electrode of the detection unit with the electrode pads of the pad unit, respectively,
wherein the detection unit, the pad unit, and the connection unit are arranged in a line.

2. The biosensor of claim 1, wherein an additional layer is plated on the reference electrode.

3. The biosensor of claim 2, wherein the additional layer is formed of a composite layer of silver and silver chloride layers or an iridium oxide layer.

4. The biosensor of claim 1, wherein an enzyme layer or a composite layer of internal and enzyme layers is formed on the working electrode.

5. A biosensor array in which a plurality of biosensors, each of which comprises a detection unit including a plurality of electrodes, a pad unit including a plurality of electrode pads to supply power to the detection unit, and a connection unit to connect the detection unit with the pad unit, the detection unit, the pad unit, and the connection unit being arranged in a line, are radially arranged at constant intervals on a substrate such that the detection unit is close to the center of the substrate,
wherein the electrode pads of the plurality of biosensors are divided in groups and are connected to separate wires, so that the same level of voltage can be applied to each group of electrode pads.

6. A method for manufacturing a plurality of biosensors, the method comprising;
forming a sacrificial layer on a substrate;
forming a lower insulating layer on the sacrificial layer;
forming a plurality of electrodes and electrode pads on the lower insulating layer;
forming an upper insulating layer on the lower insulating layer with the plurality of electrodes and electrode pads;
forming a hard mask layer on the upper insulating layer;
etching a portion of the hard mask layer and the upper insulating layer to expose the plurality of electrodes and electrode pads;
removing the remaining portion of the hard mark layer and the sacrificial layer so that the substrate is separated from the insulating layer, resulting in a biosensor array;
forming an enzyme layer or a composite layer of enzyme and polymer layers or forming a plated layer selectively on the exposed electrodes;
coating the top of the resultant structure with an external layer; and
dividing the resultant structure into individual biosensors.

7. The method of claim 6, wherein the lower insulating layer is formed of a polymer layer.

8. The method of claim 6, wherein each of the biosensors comprises a working electrode, a reference electrode, and an auxiliary electrode, the plated layer is formed selectively on the reference electrode, and the enzyme layer or the composite layer of enzyme and polymer layers is formed selectively on the working electrode.

9. The method of claim 8, wherein forming the plated layer and the enzyme layer or the composite layer of enzyme and polymer layers on the electrodes is achieved using a fluidic multi-electrochemical system comprising a lower plate having a hole to fix the biosensor array therein and an upper plate having an opening through which fluid is supplied to the electrodes of the biosensor array and having wires to supply power to the electrode pads of the biosensor array.

10. The method of claim 6, wherein dividing the resultant structure into the individual biosensors is performed using laser ablation or common cutting or plasma etching.
